(19) United States
(12) Patent Application Publication
(10) Pub. No.: US 2021/0004766 A1
(43) Pub. Date: Jan. 7, 2021

(54) DETERMINING AND MAINTAINING ORGANIZATIONAL PROJECT PARTICIPANT COMPLIANCE

(71) Applicant: Variable Systems Corp., Regina (CA)

(72) Inventors: Lonnie Mackenzie, Regina (CA); Brennan Lott, Regina (CA)

(21) Appl. No.: 16/460,238

(22) Filed: Jul. 2, 2019

(51) Int. Cl. G06Q 10/10; G06Q 10/06

(52) U.S. Cl. CPC G06Q 10/101; G06Q 10/063112

(57) ABSTRACT

A system and method for determining training compliance for projects requiring the use of project participants. A participant database including a plurality of participant records each corresponding to an individual project participant and details of at least one qualification of the associated project participant including its active or inactive status, and a project database comprising a plurality of project records each containing details of at least one associated participant role in the project having at least one required qualification for individual project participants to be assigned to the participant role. A resource matching software component will periodically monitor the active or inactive status of qualifications in individual participant records and advise projects proponents or individual project participants if any required qualifications become inactive requiring rectification regarding one or more projects. The participant record also creates a fixed and portable training and participant record for the individual workers.

### FIELD OF THE INVENTION

This invention is in the field of methods, systems, storage media, and computing platforms for determining training compliance for projects requiring the use of project participants.

### BACKGROUND

Electronic business record keeping systems enhance workflows and efficiency in many industries.

One area in which electronic record-keeping is widely used and can provide significant efficiency and workflow enhancement is that of project management. One of the key areas in project management in which information tracking is essential and in which it is believed that computer systems can help is that of tracking of worker training and skills compliance. Often it is required for various projects to guarantee that some or all of their workers assigned to work in a particular project have particular types of training courses, skills certifications. A tool which would allow for streamlined reporting or generation of this type of information based upon a particular workforce and particular project requirements would it is believed to be desirable and commercially accepted.

In the prior art there are certain previous details having been made to provide a skilled matching system the provide limited to no ability for the project proponent to limit the participants in their projects to those having appropriate skills and those having the ability to maintain all of the required skills certifications throughout the pendency of the project. This has become more and more important as regulations and project complexity increase over time.

Providing a system which would allow for an organization to quickly verify at the beginning of a project the qualifications or qualifications of one or more participants in a project, and to provide an ongoing ability to monitor the currency or status of certifications of individuals or contractors or subcontractors involved in projects would also be desirable. Having the ability to provide reporting or information management that allowed either a organization, or the employer of an individual, to monitor for example approaching certification expiry dates would it is believed to be considered of significant commercial benefit.

It would also be desirable if there were systems available that would allow for individuals, regardless of the status of their employment, to aggregate information related to their skills and qualifications so they could build a “portable” qualification profile which could move with them between employment or between projects, or could troubleshoot or qualify a particular individual or employee for participation in multiple projects simultaneously for one or more employers individual training resume or profile which could be supplemented occasionally and which could be used regardless of the status of employment.

### SUMMARY

It is the object of the present invention to provide a system and method which would allow for the monitoring of training and skills compliance on a plurality of projects by a plurality of contractors, subcontractors and employees, by permitting visibility and management of individual training certification and qualification information of individuals employed as project participants for various types of projects. This could be used in construction projects and many other types of projects which might be managed by organizations.

It is the further object of the present invention to provide a system and method of determining and monitoring training and skills compliance on a plurality of projects using human project participants, which would permit for developing a portable individualized training certification profile for each individual human project participant, which was portable beyond an individual project or their employment with a particular organization.

One embodiment of the present disclosure and invention relates to a method of monitoring training and skills compliance for projects requiring the use of human project participants. The method is specifically contemplated to be electronically implemented in a client/server environment and may include providing a server which includes a network interface for communication with client devices, along with a compliance monitoring software component for carrying out the data handling steps of the method.

The server would also comprise a participant database comprising a plurality of participant records. Each participant record would correspond to an individual project participant whom it was desired to monitor and to participate in projects managed under the method. The participant record would include participant details of the project participant and qualification particulars of at least one qualification of the project participant. The qualification particulars and the qualification would comprise a particular training completion, certification or other threshold variable it was desired to track regarding the project participant. The qualification particulars for each qualification would contain the details of the active or in active status of the qualification so the software and the method of the present invention could monitor the currency of qualifications of project participants on various projects—some qualifications might be indefinite in length and so might be always active, where other qualifications might require ongoing maintenance, the active for a particular period of time etc. and all such details of active or inactive status of the qualification are contemplated within the scope of the present invention.

The server would also comprise a project database which comprise a plurality of project records each of which corresponded to a project to be administered under the method of the present invention. Each project record would comprise project details of the project, and role particulars of at least one participant role associated with the project. Each participant role would have at least one asset requirement associated therewith. An asset requirement would correspond to attract qualification from the participant database. The role particulars would also include the number of project participants to be assigned to the participant role in the project—anywhere from one to a higher number.

The server would permit users to interact via their client devices with the server and the compliance monitoring software component through various software interfaces to update participant records and project records as required. Specifically, the server and the compliance monitoring software component would be responsible for the administration of several specific method steps as follows.

Using the server and the compliance monitoring software component, the method would comprise the creation of participant records and the participant database by, on receipt of a request to create a participant record from a user by other client device, first facilitating the data entry at the client device of participant details of the project participant. This might comprise name, address, other training or employment particulars. Besides capturing the participant details of the project participant at the client device, the method and the compliance monitoring software component via the server would facilitate the data entry of the qualification particulars for each qualification of the corresponding project participant, including the details of active or in active status of that qualification regarding the participant. Qualification particulars and their data entry could be facilitated either by providing a list or picking process in the data entry interface provided to the client device, or other types of programming and data entry will also be understood and contemplated to be within the scope of the present invention.

Once the participant details and the qualification particulars for each qualification of the proposed project participants are entered via the interface of the client device, the server would receive the transmission of the entered participant details and qualification particulars from the client device.

On receipt of a transmission of entered participant details and qualification particulars, the compliance monitoring software component would format the qualification particulars received in that transmission or packet as required so they could be stored in a format in the qualification database that will permit the compliance monitoring software component to monitor any expiry of the active status of the corresponding qualifications. Once such formatting has taken place if required, a participant record will be created and saved in the participant database which contained of the received participant details and the qualification particulars as formatted or required.

Besides actioning participant creation requests as required, the server and the compliance monitoring software component would also process the creation of project records and the project database on receiving project creation requests from the client devices of users. On receipt of a project creation request from a user client device, the compliant software component on the server wide facilitate data entry at the client device of various project details for storage within the project record to be created, and facilitating the data entry at the client device of role particulars for each participant role to be associated with the project, including all required qualifications for each project participant successfully assigned to participate in a project role. Again as in the case of the creation of participant records, the project record data entry will also be understood to potentially incorporate pick lists to cross reference qualifications between those stored in the participant database and the project database, or other means of data entry, field formatting and matching of qualifications and requirements will also be understood to be within the scope of the present invention.

Following the data entry of the project details in the role particulars for the project, the client device will transmit and the server will receive a transmission of the entered project details and the role particulars at the server from the client device.

Following receipt of the transmission of project details and row particulars at the server, the server and the compliance software component will facilitate the Association of qualified project participants to any participant roles within the received role particulars by, regarding each participant role regarding which qualified project participants are to be associated or assigned, first selecting participant records from the participant database that indicate project participants with active qualifications for the required asset requirements for the role, being the selected participant records once the selected participant records have been identified, the details of the selected participant records could be displayed on the display of the client device and the user could be permitted to select the required number of selected project participants there from for association with the participant role.

Once the association of qualified project participants as required with the necessary participant roles in the project was completed by the user and their client device, the server could receive the transmission of the asset Association details, being the details of the selected project participants and their associated participant records. A project record could be created and saved in the project database which contains the project details, the role particulars and the participant association details received.

The third function carried out by the compliance monitoring software component and the server would be the monitoring and verification of qualification compliance and at least one project, on occurrence of a verification trigger event. The verification trigger event, following which the compliance of a particular project or projects could be verified, might be several events including a manual triggering by user, predetermined and saved frequency of verification and checking, or several other types of verification trigger events understood to those skilled in the art and are all contemplated within the scope of the present invention.

Upon the occurrence of a verification trigger event, for each project record of a project to be verified the compliance monitoring software component would conduct a check for each participant role associated with the project, verify me active status of each required qualification from each participant record associated with the participant role in the project record. Any participant record corresponding to a required qualification without active status would be a noncompliant participant record requiring rectification. Any noncompliant participant records they identified would cause a notification to a designated user associated with the project record of this project, of the details of any noncompliant participant records requiring rectification. This would cause the ability for a project proponent to monitor ongoing the training compliance or the other certifications required for human assets and participants in projects. The participant record of a project participant would survive any individual act project, so it can be used across multiple projects or even in multiple employments by an individual project participant.

As outlined in further detail elsewhere herein, the verification step of the method of the present invention could be conducted regarding one or more events recognized by event records in the database is simultaneously—a single project proponent may wish to seek verification of the compliance of a project in which they are involved, or it may be desired on ongoing basis to provide verification assurance to the components of all projects managed under the method and system of the present invention. Both such approaches are contemplated within the scope of the present invention.

The verification trigger event itself could either consist of a manually triggered verification initiated from a client device in communication with the server, for example the client device of a project proponent being capable of transmitting a verification request to the server, which represented as manually triggered verification trigger event, and such a request could be initiated regarding one or more projects at the same time, or to comprise a predetermined periodic verification control for example at which time either based upon a preset interval set regarding a particular project record or regarding the entire system of verification cycle regarding one or more projects could be initiated. It will also be understood that it could be additional verification trigger events and any type of a communication for other programs initiation event regarding the compliance management software component will be understood to those skilled in the art and are all contemplated within the scope of the present invention.

In an embodiment of the method of the present invention where the project database contains more than one project record representing multiple projects, it will be understood that the multiple projects can be projects of one organization or project proponent or can be projects of more than one organization of project proponent in an embodiment of the system delivered on a service bureau basis for multiple users and organizations. Again all such approaches are contemplated within the scope of the present invention.

Similarly, a participant record of a particular project participants stored within the participant database could be associated with project records and participant roles of projects of more than one organization—this is explicitly contemplated within the scope of the present invention insofar as individual contractors or human project participants might be capable of participating in the projects of more than one organization and the method of the present invention would facilitate their participation on this basis.

Project participants within their associated participant record could store one or more qualifications. Each qualification of a project participant is a training or other type of a threshold certification possessed by a particular project participant which it might be desired to monitor from a capability perspective and to verify an ongoing basis its currency. It will be understood there are virtually limitless types of qualifications which could be stored within an associated participant record of a project participant and any qualifications of this nature will be understood to those skilled in the art of the present invention.

From a data entry perspective and from the perspective of simplifying the matching of participant qualifications and project requirements, the system might include an ability to permit users to select from the quests are preestablished qualification types are details stored in association with the compliance management software component—either from the perspective of particular qualifications it is known that project participants want to track or from the perspective of that particular project requirements it is known need to be tracked on the participant records to match to project records, it will be understood that various menus or predetermined or preset qualification types could be permitted for within the remainder of the system of the present invention and all such approaches are again contemplated within the scope.

If, following the receipt of a verification trigger event at the server and the subsequent project verification cycle regarding at least one project record it was determined there were any noncompliant participant records based upon the existence of any expired or in active required qualifications, besides identifying these noncompliant participant records of notifying a designated user associated with the related project records, the system might also initiate in such a circumstance of notification of the inactive status of a required qualification to the associated project participant subject of the related participant record, by initiating a notification to a client device or a designated user stored regarding the participant record. Various particular types of notifications again could be conceived and all are contemplated within the scope of the present invention.

Participant records in the participant database are obviously conceived to correspond to individual human project participants who could be matched to roles within projects. Additionally however it is conceived that either is participant records or as some other type of an aggregation group of individual project participants can also be tracked at group level to allow for imposing additional group level qualifications for example along with maintaining any individual participant records and individual required qualifications. For example, a particular contractor could create another participant record representing a group of all of their active employees with their own participant records and active or inactive status qualifications listed there on, so the group level participant record can be assigned to roles within projects and would allow for tracking of group level qualifications along with any associated individual qualifications of individual project participants within the aggregated group. Any necessary modifications or refinements to the system and method of the present invention to achieve this type of an aggregated group level tracking will be understood to be within the scope of the present invention.

The hardware used to conduct the method of the present invention can take many types or formats. It is specifically contemplated for example that the server could be a Web server, the network interface of the server could connected to the Internet and the client devices could be Internet enabled and connected devices capable interaction with the server and its related software component. Any type of a hardware infrastructure design which will permit for the achievement of the method of the present invention will be understood to those skilled in the art of same and is contemplated within the scope of the present invention.

A further embodiment of the invention comprises a server configured for determining training and skills compliance for projects requiring the use of project participants, the computing platform comprising a non-transient computer-readable storage medium having executable instructions comprising a compliance monitoring software component embodied thereon; a participant database comprising a plurality of participant records each corresponding to an individual project participant and comprising details of at least one qualification of the associated project participant including its active or inactive status; a project database comprising a plurality of project records each corresponding to a project and comprising details of a plurality of associated participant roles in the project each having at least one required qualification for individual project participants to be assigned to the participant role; a network interface for communication with client devices; and one or more hardware processors configured to execute the instructions of the compliance monitoring software component.

The server will facilitate the method of project compliance monitoring by:
a) permitting users to interact via client devices in communication with the server and the compliance monitoring software component to update participant records and project records as required;
b) on receipt of a participant creation request from a user via a client device:
   i) facilitating data entry at the client device of participant details of the project participant;
   ii) facilitating data entry at the client device of the qualification particulars for each qualification of the corresponding project participant, including the details of active or inactive status of the qualification;
   iii) receiving a transmission of the entered participant details and qualification particulars at the server from the client device;
   iv) formatting the qualification particulars received as required so that they can be stored in a format that will permit the compliance monitoring software component to monitor any expiry of the active status of the qualifications; and
   v) creating and saving a participant record in the participant database containing the received participant details and qualification particulars;
c) on receipt of a project creation request from a user via a client device:
   i) facilitating data entry at the client device of project details;
   ii) facilitating data entry at the client device of role particulars for each participant role to be associated with the project including all required qualifications for each project participant to be assigned to each participant role;
   iii) receiving a transmission of the entered project details and role particulars at the server from the client device;
   iv) facilitating the association of qualified project participants to any participant roles within the received role particulars by, for each participant role:
      (1) selecting participant records from the participant database that indicate project participants with active qualifications for the required qualifications for the role, being the selected participant records;
      (2) displaying the details of the selected participant records on the client device and permitting the user to select the required number of selected project participants therefrom for association with the participant role;
   v) receiving a transmission of the participant association details, being the details of the selected project participants and their associated participant records, to the server; and
   vi) creating and saving a project record in the project database containing the project details, the role particulars and the participant association details; and
d) verifying the qualification compliance of at least one project on occurrence of a verification trigger event by, for each project record of a project to be verified:
   i) for each participant role associated with the project, verifying the active status of each required qualification from each participant record associated with the participant role in the project record, any participant record corresponding to a required qualification without active status being a noncompliant participant record; and
   ii) if any noncompliant participant records are identified regarding the project, notifying a designated user associated with the project record of the details of any noncompliant participant records requiring rectification.

Specific embodiments of the method conducted by the server will be within the scope of those outlined elsewhere herein.

The tracked participant qualifications of participants in participant records, and the corresponding required qualifications in respect of projects in project records can be selected from the group of: physical or geographic locations of residence, physical or geographic locations availability for work, completion of particular educational courses or diplomas, completion and maintenance of particular ongoing professional certifications, or possession of particular training and skills.

Upon the completion of a project represented by a project record, the participant records of any human participants associated with participant roles within the project are modified to store and indication of the participation of the corresponding human participant in the completed project, whereby future database queries related to the participant records in question can reveal a completed project log in respect of the associated participant. In such embodiments, tracked participant qualifications of participants in participant records, and the corresponding required qualifications in respect of projects in project records, can be past project experience of a participant as stored in respect of their participant record.

The server outlined and disclosed will facilitate the completion of compliance monitoring transactions regarding projects administered under the method of the present invention. The server and the compliance monitoring software component can also provide functionality by which at least one participant record can be accessed in a general participant search outside of its association with a particular project record.

Using the system and method of the present invention a project proponent could ensure that they were always selecting and assigning qualified HR resources to projects under their administration, and that the certifications or qualifications of those HR resources were maintained in a current form throughout the active time of the project. If any required qualification expired during the project, the project proponent would receive via a designated user a notification of the expiry of this qualification requiring rectification or the assignment of a new resource.

From the perspective of a project participant, besides providing a streamlined ability to assure training qualifications and their active status to potential employers or project administrators, the project participant would also gain the ability to build an ongoing qualification record that they could use occasionally as required, which would survive any particular project or employment.

These and other features, and characteristics of the present technology, and the methods of operation and functions of the related elements of structure and the combination of parts and economies of manufacture, will become more apparent upon consideration of the following description and the appended claims referring to the drawings, which form a part of this specification, wherein like reference numerals designate corresponding parts in the figures. It is to be understood, however, that the drawings are for illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

While the invention is claimed in the concluding portions, preferred embodiments are provided in the detailed description which may be best understood with the diagrams where like parts in each of the several diagrams are labeled with like numerals, and where:

FIG. 1 is a flowchart demonstrating steps in one embodiment of the overarching method of the present invention;

FIG. 2 is a broken out flowchart demonstrating the steps involved in a participant record creation transaction, as stated in FIG. 1;

FIG. 3 is a broken out flowchart demonstrating the steps involved in a project record creation transaction, as stated in FIG. 1;

FIG. 4 is a broken out flowchart demonstrating the steps involved in a project verification transaction, as stated in FIG. 1;

FIG. 5 is a schematic of a sample embodiment of a system which could achieve the method outlined;

FIG. 6 is a block diagram showing the components of an embodiment of a server under the present invention;

FIG. 7 is a sample schematic drawing of one data structure for the data store under some embodiments of the present invention, demonstrating the key components of the anticipated record structure;

FIG. 8 is an entity diagram showing the various data types to be stored and monitored in respect of participants in accordance with embodiments of the method of the present invention; and

FIG. 9 is an entity diagram showing the various data types to be stored and monitored in respect of participants in accordance with embodiments of the method of the present invention.

### DETAILED DESCRIPTION

As outlined above it is the object of the present invention to provide a system and method for the consolidated information management required for determining training compliance by individuals or contractor groups involved in projects requiring project participants. The following provides additional information. To appreciate the functionality of the present invention it is beneficial to establish certain terminology used in the remainder of the specification to describe the invention.

### Projects:

As outlined throughout, the two entity types tracked in the facilitation of the method of the present invention are participants 40, being human participants 40 who would work in projects 45 administered and monitored in accordance with the invention, as well as projects 45. The server 1 and method of the present invention as outlined herein can be used to monitor the qualification compliance of any number of projects 45 in which human participants 40 are required. It is specifically contemplated that the system and method of the present invention would be useful in construction management and related types of projects 45, although there is virtually a limitless number of types of projects 45 requiring oversight or compliance monitoring which could benefit from the use of the server 1, software and method of the present invention.

The method of the present invention is intended for use in the monitoring of individual participant compliance regarding the required qualifications for projects 45—i.e. it is intended for monitoring the currency and status of required participant skills from an individual or team level for human individuals to be assigned to or engaged in the conduct of different projects 45. Any type of a project 45 having a plurality of participant roles 47 associated therewith that might require human individuals to assist in their execution, and regarding which roles one or more types of training requirements, certifications or other qualifications are required, will be understood to be contemplated within the scope of the present invention.

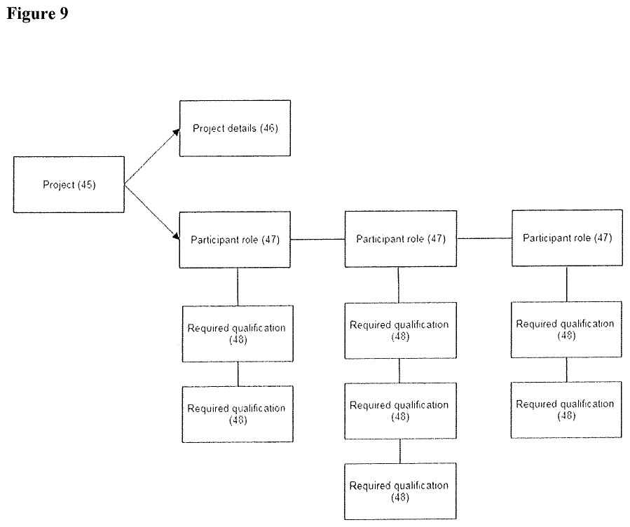

FIG. 9 is an entity diagram intended to demonstrate the different types of data or information required or intended to be tracked and monitored in respect of projects 45 in respect of the method of the present invention. There is shown an entity project 45, with project details 46 associated therewith. As detailed throughout, the project details 46 which would be captured and stored in respect of the project 45 in a corresponding project record 14 are descriptors or other information not required for use in the participant role and qualification monitoring method of the present invention that might be descriptive of the project 45—for example project name, proponent name, details of the project which would be shown in various reporting and queries, and the like.

Each project 45 would have at least one participant role 47 associated therewith. The participant roles 47 might include specific trades or training types, or other different roles or skill categories associated with a particular project 45. As outlined throughout, the project 45 could be of many different technical types. The participant role 47 might require one or more people to be assigned to it and the number of required participants could be stored along with the remainder of the participant role 47 details.

This Figure shows three participant roles 47 associated with the particular project 45. Obviously anywhere from one to many is the number of participant roles 47 which should be assigned for monitoring and testing in association with the remainder of the method of the present invention. Each participant role 47 could in turn be configured for one or more than one human asset to be associated therewith.

Each participant role 47 has at least one required qualification 48 associated therewith. The required qualifications 48 are the qualification indicators required for each individual human asset to be associated with the related participant role 47. In the case of the three participant roles 47 shown in this Figure for demonstrative purposes, two of them show two required qualifications 48 while a third participant role 47 shows three required qualifications 48 associated.

Some projects 45 which might require human resource monitoring such as that would be provided by the method of the present invention might also include the need for the monitoring of the active or inactive status of certifications or other qualifications in other non-human assets i.e. systems, tools, venues and the like, and it will be understood by those skilled in the art that the method of the present invention can be further modified to be extended to such inanimate assets as well.

It is specifically contemplated that the system and method of the present invention could be used to permit participants 40 to work on projects 45 of more than one project 45 proponent i.e. that the method at the server 1 of the present invention could effectively be operated as a service bureau to support many project proponents, besides obviously potentially being administered on behalf of a single project proponent. Both such approaches are contemplated within the scope of the present invention.

### Project Roles:

Projects 45 administered under the method of the present invention will be any project 45 having at least one participant role 47 associated with the project 45 regarding which a human participant 40 would be required. The participant role 47, which would be tracked under the method of the present invention, would be a particular task within a project 45 for which a human asset was required as a participant 40 to administer or execute, and that participant 40 needed to have at least one required qualification, which would require status monitoring under the method of the present invention. The software method of the present invention is intended to not only permit the rapid identification of appropriately trained or certified human resources for assignment as participants 40 to particular participant roles 47 in projects 45 administered under the method of the present invention, but also to monitor the maintained currency of the required qualifications 48 throughout the project 45 basically to ensure that from the perspective both of individual participants 40 involved in the project 45 and project proponents who might for example be subjected to significant regulatory requirements or the like, to ensure that throughout the currency of their projects 45 the required qualifications 48 of participants 40 providing services remain current. I.e. Individual workers involved in a project 45 lost no required certification or training and qualifications needed for the administration or completion of the project 45, during the term of the project 45.

Besides monitoring the details of participant roles 47 and participant qualifications 42 that need to be maintained current, the system and method of the present invention could also allow for the tracking in the participant records 12 of individual participants 40 of additional qualifications are training which did not have the need for monitoring of active or inactive status. For example, certain types of training courses or the like might simply need to be completed rather than maintained currently in the system can also attract those—the fact that the course had even been completed could effectively represent an active status qualification, versus the need to maintain on a periodic basis upkeep of those items etc. It will be understood that the method of the present invention could incorporate additional participant qualification 42 tracking for qualifications that did not require ongoing upkeep so the active or inactive status was monitored either in a more binary way—i.e. only in existence of a particular training qualification, at that point being an active status qualification—or that certain participant qualifications 42 might not be tracked from a status perspective at all and adding this functionality besides the ability to track the active or inactive status of certain required qualifications 42 is also contemplated within the scope of the present invention.

It is specifically contemplated that each project 45 role in a project 45 could have the need for one or more individual human participants 40 to be assigned thereto.

### Participants:

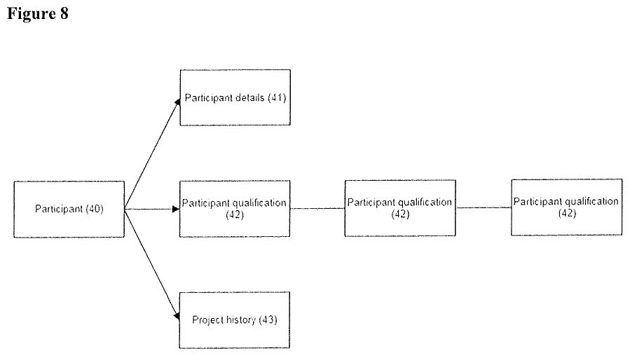

FIG. 8 is an entity diagram demonstrating the different types of data which would be captured, monitored and stored in respect of individual participants in respect of the method of the present invention. For each participant 40 there is shown first entity block representing participant details 41. Participant details 41 would be used regarding each individual participant 40 who wished to be monitored under the system of the present invention. Those details might include names and addresses etc. but might also include for example a geographic limiter so that geographic filtering could be done in the selection of participants 40 to participate in projects 45, or several other different details. The participant details 41 are various identifying information—name, address, or other types of information—there is virtually limitless type of participant details which could be captured and stored for query and reporting purposes.

In respect of each participant 40 the system will also track at least one participant qualification 42 in respect of an individual or team. A participant qualification 42 is any type of a training, certification or other limiting factor which could be used to determine the compliance of a particular identified participant 40 with a particular role 47 in a project 45. Also shown in FIG. 8 is project history information 43 which might in some embodiments of the method of the present invention be stored in respect of a particular participant 40 i.e. the system could be configured to maintain a law of projects completed or otherwise in respect of which the participant 40 was an associated participant to a particular kind of a role 47.

The participants 40 in a project 45 would be human individuals who would participate in the conduct of particular tasks or roles within the project 45. Using a construction project 45 as an example, there might be the need for carpenters, electricians and plumbers—each role within the project 45 would require at least one individual participant 40 assigned to fulfil the role within the project 45. In certain cases a particular role might require the assignment of multiple individual participants 40—for example where a larger project 45 required for example five or six electricians instead of one, five or six individual electrician participants 40, having participant records 12 established in the system of the present invention, could be used.

It is also specifically contemplated one benefit of the system of the present invention would be that individual participants 40 who work for multiple employers, or even individual contractors who do not work for a larger contracting organization, could work on projects 45 by allowing themselves to be easily matched to participant roles 47 for which they were qualified. Particularly given the fact that the individual participant 40 would be the effective director of the content and currency of their participant record 12 and that it is specifically intended that the participant record 12 would not be tied to any particular project 45 or any particular employment, the utility of the system to individual participants 40 can be seen in further detail.

As well it is explicitly contemplated that another type of a participant record 12 which could be created with relate to a group participant 40 for example, a company or a team of individuals regulated as a group could also create another participant record 12 by which they can participate in the assignment to particular participant roles 47.

### Participant Qualifications:

As outlined throughout this document, the key aspect of the method of the present invention is tracking the details of the currency or status of various qualifications 42 of human participants 40 so participants 40 with current required qualifications can be matched and monitored regarding particular participant roles 47. Participant qualifications 42 could include everything from something like having completed a particular type of college or university diploma, through to more specific vocational training or certifications which require periodic upkeep, fees. Any participant qualification 42 capable of being tracked in a participant record 12 along with a formatted indicator of its active or inactive status will be understood to be within the scope of the present invention. As outlined in further detail below, simply the fact that it participant 40 possesses a particular qualification may be the indicator of active status for that qualification, whereas for other qualifications it may be necessary to provide ongoing upkeep etc. and the system and method of the present invention would also permit the participant 40 or someone acting on their behalf to occasionally update their corresponding participant record 12 to maintain the currency and the active status of their various qualifications so it would not impact negatively their ability to participate within projects 45 to which they have been or will wish to be assigned.

### Method Overview:

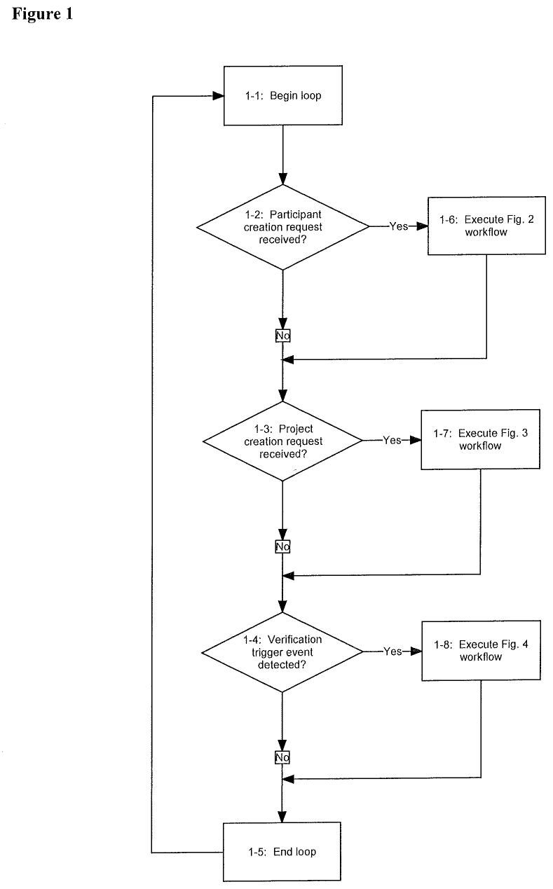

Referring now to FIG. 1 there is shown a flowchart demonstrating the steps of one demonstrative embodiment of the method of the present invention, which is a method of monitoring training and skills compliance for projects 45 requiring the use of human project participants 40. The method is conducted using a server 1 which includes a network interface for communication with client devices 2. As outlined in further detail elsewhere herein, the network interface is contemplated to likely be a Internet network interface and the client devices 2 would be capable of communicating with the server 1 using the Internet or other widely available public network. Practice of the method of the present invention using a client/server 1 hardware architecture results in the ability to offer the best functionality to a wide group of geographically dispersed clients, while centralizing the computing operations required to facilitate the method at the centrally located server 1.

Besides a network interface for communication with client devices 2, the server 1 also includes a compliance monitoring software component 7, for carrying out the data handling steps of the method. The specific detail of the compliance monitoring software component 7 is outlined below, but generally that component 7 comprises a software with the necessary processor instructions to enable the server 1 to conduct the necessary communication and data operations to effect the method.

There are two datasets required and hosted on or accessible to the server 1 for the facilitation of the method as well. These include a participant database and a project database. The participant database consists of a plurality of participant records 12 each of which corresponds to a project participant 40. The participant record 12 of a particular human project participant 40 includes participant details 41 of the project participant 40, such as their name and or other identification particulars or the like, as well as qualification particulars 42 of the human participant 40 regarding at least one qualification 42. The qualification 42 of the participant 40 is a particular training certification, qualification or other parameter which can filter the applicability of the particular participant 40 represented by the participant record 12 to a particular role within a project 45 administered under the remainder of the method of the present invention.

Qualification particulars 42 for each qualification 42 tracked regarding each participant 40 represented by participant record 12 also include the details of the active or inactive status of the qualification. This is to facilitate the method insofar as the entire focus of the method is to allow for the imposition and enforcement of a training requirement matrix or a certification matrix of various human project participants 40 upon projects 45 requiring multiple human project participants 40 in various roles. As outlined in further detail elsewhere below some of the qualifications 42 of a particular participant 40 could be considered active simply by their existence—for example the fact that the participant 40 had completed a particular level of schooling, training diploma or the like, would always be active and so could be tracked as an active qualification regarding the participant record 12 corresponding thereto. For other types of qualifications where ongoing maintenance, fees or other types of activities or conduct of the participant 40 to maintain the currency of a particular qualification or required, date fields based on which active or inactive status of the qualification could be determined or other similar fields could be used within the participant record 12 or in association with the participant record 12 to allow the compliance monitoring software component 7 to at the appropriate time assess the active or inactive status of the corresponding qualification. An example of a qualification 42 which could be inactive or active could be for example a lawyer whose license to practice law depended upon maintaining their fees and other current requirements with the local Law Society or regulator and if the fees are the current requirements were not maintained, or if a particular date were reached at which the current status of the qualification would expire, then upon testing the current status of the qualification, the compliance monitoring software component 7 could determine the inactive status of such qualification. These qualifications 42 are listed only for demonstration of the idea of a always active qualification, or a qualification 42 which could be considered active or inactive based upon expiry based on numerous parameters. Any qualification which could be accommodated within a flexible data structure of the participant database could all be contemplated within the scope of the present invention.

Besides the participant database, the server 1 would also include access to a project database which comprise a plurality of project records 14 each of which corresponded to a project 45 to be administered under the method of the present invention. Regarding each project 45, the project record 14 would include project details 46 regarding the project 45—for example a description of the project 45, details of the project proponent, notification details or security credentials for individuals able to access the contents of that record through a user interface of the server 1, or other similar types of information. Besides the project details 46, the project record 14 would also include role particulars for at least one participant role 47 to be associated with the project 45. In project 45 management methodology, a project 45 can be broken down into one or more participant roles 47 each of which would have role particulars. For example, for a construction project 45 with an electrical component, the participant roles 47 would include the need for at least one electrician. If the electrical work was commercial, the electrician may need to have a commercially rated electrical license or permit. Projects 45 could have a virtually unlimited number of participant roles 47 associated with them—several participant roles 47 are contemplated within the scope of the present invention.

As outlined, each participant role 47 will be represented by role particulars captured and stored within the project record 14 which might describe aspects of the role and requirements for the particular participant 40 or participants 40 to be assigned thereto—one or more participant 40 to be assigned to each participant role 47—and each participant role 47 in its role particulars would include at least one required qualification 48. In the example provided above the required qualifications 48 would include that the individual human participant 40 would need to be electrician and would need to have a commercial electrical permit. Those could be two required qualifications 48 tracked regarding the particular participant role 47 of the project 45, which could be used for identifying corresponding and qualified human participants 40 and testing the ongoing capability of the assigned human participants 40 on an ongoing basis in monitoring the compliance of the project 45 and the team assigned thereto.

The at least one required qualification 48 tracked regarding at least one participant role 47 of a project 45 would correspond to tracked qualifications from the participant database, so that at least one project participant 40 could be matched from the participant database and assigned regarding the participant role 47.

It will be understood that many different hardware and software combinations to be used to facilitate the computerized aspect of the method of the present invention and that the general description of the infrastructure outlined above is only one example. Different designs and different data structures of the databases for example would be conceivable questions skilled in the art of hardware and software design in the problem area, and any such approaches are all contemplated within the scope of the present invention.

The server 1 would permit users, using client devices 2, to communicate with the server 1 and the compliance monitoring software component 7 to update participant records 12 and project records 14 as required. The server 1 could provide via the network interface to client devices 2 either using a browser or a local software application installed thereon an interface through which participant records 12 and project records 14 could be updated or created as required. The creation of the records as outlined in specific method steps below, but the interface of the server 1 to the client devices 2 could also explicitly provide the ability for users to update participant records 12 and project records 14 as required where for example a participant 40 wished to add the details of additional participant qualifications 42 to their corresponding participant record 12, modify the current status of the particular qualifications 42 stored within a participant record 12, or where regarding a project record 14 it was desired to add or delete participant roles 47 and participant assignments therefrom.

The method in FIG. 1 represents a loop in which effectively three subroutines would be monitored and administered or triggered as required occasionally based upon an appropriate interaction between the server 1 and the client device 2 or otherwise. The loop is shown at 1-1. While the method in this loop is represented as a multistep flowchart demonstrating the triggering of various subroutines based upon the occurrence of various trigger events, again the order of these items in the flowchart or the other specific implementation of the software will be understood to take multiple forms based upon different software designs or architectures and any type of the software design which would allow for the accomplishment of the multiple steps of the method as claimed in otherwise outlined is all contemplated within the scope of the present invention.

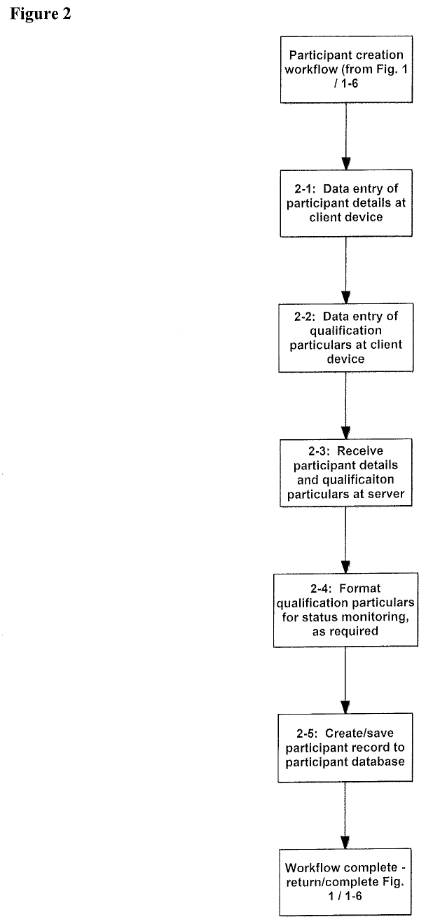

The first subroutine contemplated by the flowchart of FIG. 1 is the subroutine related to the creation of a participant record 12 in the participant database based upon receiving a participant record creation request by the server 1. This is shown at 1-2. It is contemplated that usually a participant record creation request, as referenced at step 1-2 of the method shown, would be triggered by user of a client device 2 and network communication with the server 1. If the server 1 receives a request to initiate the creation of a participant record 12 in the database, the “yes” leg of the decision below is shown in this step demonstrates the execution of the workflow in FIG. 2, as referenced in Step 1-6. Once the subroutine of FIG. 2 is completed and the operation returned to this primary workflow, the loop could continue to monitor for additional trigger events and conduct other necessary events and actions under the remainder of the method.

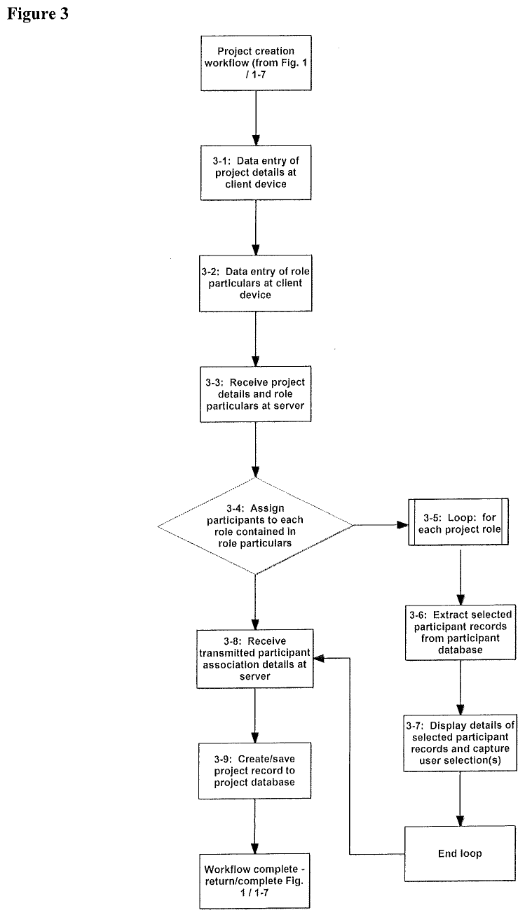

Shown at Step 1-3 is another decision block in which the compliance monitoring software component 7 executed on the server 1 could upon receipt of a project 45 creation request at the server 1 trigger a project 45 creation workflow, as shown in FIG. 3 and as called at step 1-7. Once the subroutine in FIG. 3 were completed and the related project record 14 created in the database, the operation will return to this primary workflow the loop could continue to monitor for additional trigger events and conduct of the events and actions under the method.

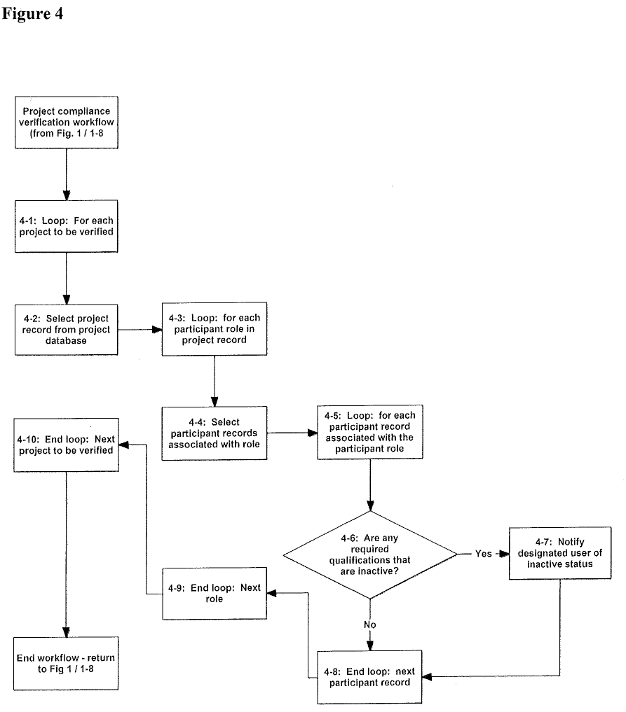

The third decision block in the monitoring loop of FIG. 1 is a decision block based upon the receipt by the server 1 or the detection by the server 1 of a verification trigger event. This is shown in step 1-4. A verification trigger event is an event triggering the conduct of a project compliance test to be applied by the compliance monitoring software component 7 to one or more projects 45 tracked in the project database. On detection of a verification trigger event, the server 1 could trigger the project verification workflow is shown in FIG. 4 and is called at step 1-8. Following the completion of the project verification subroutine in FIG. 4, operating the method would return to this primary workflow and the monitoring loop again could continue. Completing the monitoring loop is shown at step 1-5. The project compliance monitoring component of the method of the present invention can also be conducted on an ongoing monitoring basis, whereby the software would be modified to continually monitor the contents of the participant database and to immediately initiate notification of noncompliance to designate parties associated with particular projects 45 when the active status of any required qualification is detected having been lost. The necessary modifications to the software and method outlined herein to achieve this kind of an ongoing monitoring approach will be understood to those skilled in the art and is obviously all contemplated within the scope of the present invention as well of the present time.

The primary method outlined in FIG. 1 is demonstrated referring to three off page subroutines related to the execution of particular data creation and manipulation requests. In the first case, demonstrated in the testing decision block of 1-2, within the monitoring loop the compliance monitoring software component 7 would listen for receipt at the server 1 of a request for creation of a participant record 12. On receipt of a participant creation request from a user via a client device 2, the server 1 and the compliance monitoring software component 7 would conduct several steps to execute the participant creation request and create a resulting participant record 12 in the participant database. This subroutine is demonstrated in FIG. 2. The first step of the participant creation workflow demonstrated in this Figure is the facilitation of the data entry of participant details 41 via a user interface of a client device 2. This is shown at step 2-1. As discussed elsewhere herein, the user interface of the client device 2 could facilitate data entry to the server 1 and the compliance monitoring software component 7 via a browser interface of the client device 2 in communication with the server 1 and the related software component 7, or a locally installed software app to facilitate direct data entry and transactions with the server 1 and the compliance monitoring software component 7 could also be developed in both such approaches are contemplated within the scope of the present invention.

Besides the data entry of participant details 41 at the client device 2, the next step in execution of this subroutine would be the facilitation by the server 1 in communication with the client device 2 of the data entry of qualification particulars 42 of this participant 40 at the client device 2. Data entry of qualification particulars 42, which would include information based upon which the active or inactive status of individual qualifications could be determined or monitored was formatted correctly is shown at step 2-2.

Following the data entry of participant details 41 and qualification particulars 42 at the client device 2, the server 1 would receive a transmission or packet containing the participant details 41 and qualification particulars 42 entered at the client device 2 by the network interface. This is shown at step 2-3. The particular format or detail of the transmission of this information from the client device 2 to the server 1 will be understood to those skilled in the art as being capable of being accomplished in many steps or workflows and any reasonable modification to the workflow in terms of the order or nature of the steps which achieve the ultimate objective of the transmission once captured of this information to the server 1 are all contemplated within the scope of the present invention.

Following the receipt of the participant details 41 and related qualification particulars 42 at the server 1, step 2-4 demonstrates a data formatting step at the server 1. The server 1 in the compliance monitoring software component 7 would format as required the qualification particulars 42 received in a transmission of participant details 41 and qualification particulars 42 for the creation of the participant record 12, to allow for status monitoring. Any cleaning, reformatting or conformity of the qualification particulars 42 to achieve a standardized format in the format required by the ultimate design and programming at the compliance monitoring software component 7 to allow for periodic currency testing regarding a particular corresponding qualification will all be understood to be within the scope of this step.

Following any necessary formatting in Step 2-4, the compliance monitoring software component 7 would create and save a participant record 12 in the participant database. Following the creation and saving of the participant record 12 this subroutine is complete and the workflow would return to the primary workflow demonstrated in FIG. 1, specifically carrying on to Step 1-3 as shown.

The second subroutine, detailed in FIG. 3, is a subroutine related to the establishment of a project record 14 in the project database based upon receiving a project record 14 creation request by the server 1. Again the server 1, in communication with the client device 2, would capture the information to facilitate the data transaction of this Figure. Shown at step 3-1, the server 1 in communication with the client device 2, either using a browser or local software application on the client device 2, would facilitate the data entry of project details 46. The project details 46 will be several types of basic information which it was desired to capture regarding the project 45 for which the project record 14 was to be created. This might include the name of the project 45, longform text or document attachments being submitted for download or viewing by participants 40 or other parties, name or contact particulars of one or more authorized users or other individuals related to the project 45 which might be desired either for credential to allow authentication of users to modify the record to be created, or to inform viewers of the details of the record, date ranges for the currency or length of the project 45 or other similar information which could filter applicable participant records 12 and active required qualifications 48 or any other information.

Besides the basic project details 46, the client device 2 and server 1 combined with software component 7 would facilitate the data entry at the role particulars to be associated with the project 45. Role particulars would need to be acquired regarding each participant role 47 to be associated with the project 45, including all required training requirements or other required qualifications 48 which might be required for a project participant 40 to be assigned to that participant role 47.

Following the data entry of the role particulars at the client device 2 and completing step 3-2, the entered project details 46 and role particulars would be transmitted or received at the server 1, shown in step 3-3. Following the receipt of a project 45 transmission including project details 46 and role particulars at the server 1, shown in this step, the server 1 and software component 7 would parse that material into the necessary information to conduct the next step in the methods which is the association of qualified project participants 40 to any participant roles 47 within the received role particulars.

The association of qualified project participants 40 to participant roles 47 for the project record 14 is shown at step 3-4. A subroutine or loop for each project 45 role is shown at 3-5. For each participant role 47, the compliance monitoring software component 7 or other software component 7 would first extract a selected subset of participant records 12 from the participant database—this is shown at step 3-6. The selected subset of participant records 12 are any participant records 12 for whom the stored qualifications represent an active participant qualifications 42 corresponding to any required qualifications for the participant role 47.

Following the extraction of the selected participant records 12 from the participant database, the server 1 in conjunction with the client device 2 would displaying the details of the selected participant records 12 to the user of the client device 2 and capture user selections from the user of the client device 2 corresponding to the number of required participants 40 to be associated with the particular participant role 47. The display, selection and capture of user selections is shown at step 3-7. The end of the subroutine loop is also shown following step 3-7.

Once the user of the client device 2 has in communication with the server 1 and software 7 completed the association of qualified participants 40 with each participant role 47 in the project 45, the details of the selections would be received back at the server 1—shown at step 3-8.

Following the receipt of the transmitted participant association details, the compliance monitoring software component 7 will create and save a project record 14 storing the received information in the project database, shown at 3-9. This would conclude the project record 14 creation data transaction and the control would be passed back to the primary workflow of the compliance monitoring software component 7 in FIG. 1.

The third primary data transaction which it should encompass in the method of FIG. 1 is a project verification transaction in which the compliance of a project 45 and all of its related participants 40 would be tested by the compliance monitoring software component 7 to ensure that any required qualifications of all participants 40 associated with all roles in the project 45 remained active in status. This is shown in the subroutine of FIG. 4.

The verification transaction would be triggered by the detection by the server 1 of a verification trigger event. This could be a manual trigger event communicated to the server 1 from a client device 2, a preprogrammed periodic frequency or several other types of events. Any type of a detectable condition which could have the server 1 trigger a data verification and compliance transaction is contemplated within the scope.

A verification trigger event could be applied to one or more projects 45 and the related project records 14—the system could for example occasionally verify all of the projects 45 within the project database, or only a single or subset of project records 14 could be reviewed. Any such approach will be understood to be covered within the scope.

Upon detection of a verification trigger event, shown at Step 1-4 of FIG. 1, the project verification 713 of FIG. 4 would be triggered—shown at step 1-8. The subroutine of FIG. 4 is of project 45 compliance verification workflow. It consists of a loop to be executed regarding each project 45 to be verified—the beginning of the loop is shown at step 4-1. It is anticipated that the subroutine demonstrated in this Figure could be run either in series or in parallel regarding every project record 14 regarding which the project 45 compliance verification workflows to be executed.

Upon commencement of the workflow, the project record 14 related to the project 45 would be selected from the project database—shown at step 4-2. Following the selection of the project record 14 from the database regarding which is desired to conduct a verification, a loop will be commenced for each participant role 47 outlined in the project record 14—this nested loop is shown at 4-3. Inside this nested loop, for each participant role 47 in the project record 14 the software will select the participant records 12 of participants 40 associated with the participant role 47. This is shown in step 4-4. Related participant records 12 of associated participants 40 would be identified from the data stored either in the project record 14 or in a related data structure providing a concordance between participant records 12 and specific participant roles 47 and the participant database.

There is a further nested loop conducted, shown at 4-5, regarding each participant record 12 associated with the participant role 47 being tested. The compliance monitoring software component 7 would examine the details of any participant qualifications 42 and the active or inactive status thereof stored within the related participant record 12, that correspond to required qualifications outlined in the participant role 47 requirements in the project record 14. If any required qualifications are inactive [testing decision block at 4-6] the software would notify a designated user associated with the project record 14 of the inactive status of the related participant 40, for rectification. This is shown in step 4-7. The end of the loop testing the participant records 12 is shown.

If none of the participant records 12 associated with the participant role 47 contain any inactive qualifications, the end of the participant role 47 loop is also shown at step 4-9 and testing the next if any participant role 47 associated with the project record 14 would be conducted. Following the completion of that loop 4-10, the verification of required qualifications regarding the next project record 14 to be verified would be conducted.

Following the completion of the project 45 compliance verification workflow in FIG. 4, the workflow would return to the primary workflow of FIG. 1 and back to the monitoring or listening loop. It will be understood that the specifics of the verification workflow in FIG. 4 and as to be conducted by the compliance monitoring software component 7 could take many forms and the workflow in that particular flowchart is just one demonstrative example. Any type of a software workflow that would cause testing the active status of any required qualifications 42 of any associated participant records 12 associated with all of the project records 14 to be tested will be understood to be within the scope of the present invention.

The entire workflow FIG. 1 as outlined above also could be modified and is really to shown as one the sample embodiment of an overarching software loop consisting of several subroutines which could be triggered upon the detection of several triggering conditions at the server 1.

Having reviewed the overarching methodology, we will now review several specific aspects and embodiments of method steps and related server 1 and system architecture required to effect the method of the present invention.

### Demonstrative System and Server Embodiment:

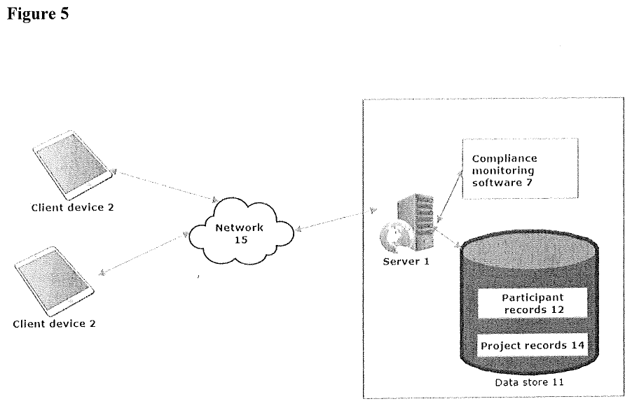

Referring to FIG. 5 there is shown one sample embodiment of a system which could conduct the method of the present invention as outlined otherwise herein. There is shown a server 1 with a compliance monitoring software component 7 associated therewith and a data store 11 containing a plurality of participant records 12 and a plurality of project records 14.

The server 1 has a network interface connected to a wide-area network shown at 15. A plurality of client devices 2 are shown which could communicate with the server 1 through the network 15. The client devices 2 could communicate with the server 1 either using a browser software if the server 1 contains Web server 1 components which would facilitate the use of a browser type communication, or in other embodiments, the client device 2 could install a purpose built local app to be used to facilitate the method of the present invention.

### Server 1 Architecture:

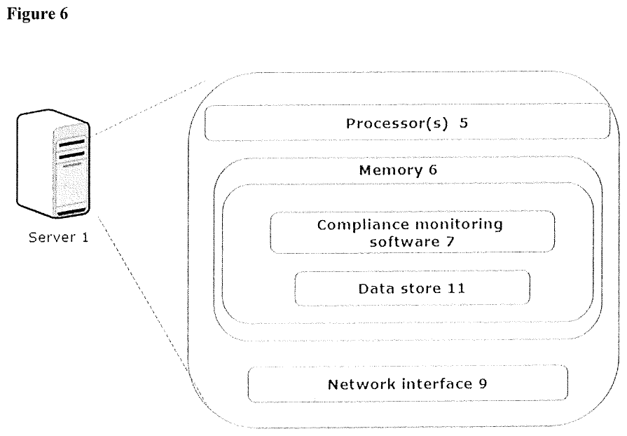

The overall architecture would be client/server 1 in nature and would rely on server 1 configured for the monitoring of training and skills clients for projects 45 requiring the use of human project participants 40, under one or more implementations. The server 1, a sample embodiment in which is shown in FIG. 6, might consist of one or more servers 1—a single server or a server farm approach. The server 1 would comprise one or more processors 5 and memory 6. The memory 6 might include various processor instructions for the method of the present invention or otherwise in operating the server 1. Processor instructions corresponding to the compliance monitoring software component 7 are shown stored within the memory 6 in this Figure. The server 1 may be configured by machine-readable instructions, which may include one or more instruction components. The instruction components may include one or more of server 1 firmware or operating systems, the compliance monitoring software component 7, and/or other instruction components.

Memory 6 may comprise non-transitory storage media that electronically stored information. Electronic storage media of memory 6 may include one or both of system storage provided integrally with server 1 and or removable storage that is removably connected to the server 1 via, for example, a port or a drive. Memory 6 may include one or more of optically readable storage media, magnetically readable storage unit electrical charge based storage media, solid-state storage media and or other electronically readable storage media. Memory 6 may include one or more virtual storage resources i.e. cloud storage, a virtual private network or the like. Memory 6 may store software algorithms, information determined by processors 5, information received from server 1s 1, information received from client devices 2 and or other information that enables the server 1 in a want to function as described as outlined herein. The processor 5 may be configured to provide information processing capabilities in the server 1. Processor 5 may include one or more of a digital processor, an analog processor, a digital circuit design and process information, and analog circuit designed to process information, state machine and/or other mechanisms for electronically processing information. Although the processor 5 is shown regarding this Figure as a single entity, this is for illustrative purposes only. In some implementations the processor 5 may include a plurality of processing units which may be physically within the same device, or may represent processing functionality of a plurality of devices operating in coordination.

In many embodiments the server 1 is contemplated to be a Web server 1, where client devices 2 would use a web browser or a locally installed software application for interaction therewith via a network communication or a call. Where a local application was developed, the server 1 might not be a Web server 1 per se but might be a network server 1 capable of interaction with the type of an interface on the remote client devices 2 required to facilitate the operation of that software application. Either such approach is contemplated within the scope.

Server 1 would poster be operatively connected to a data store 8. Besides the general operating system instructions the server 1 would comprise a compliance monitoring software component 7 which would be responsible for execution of the process and method of the present invention at the server 1 and coordinating communication with customer client devices 2. The compliance monitoring software component 7 might itself act as the interface between the remainder of the hardware and software of the server 1 and the data store 8, or the server 1 might include additional software interfaces to the data store 8.

The compliance monitoring software component 7 would comprise subroutines to administer the data store 8, creating, modifying and processing participant and project transactions and records in the data store 11 and any additional financial or numerical transactions, searches are reporting as required. The details of operating the compliance monitoring software component 7 are outlined elsewhere in this document.

Server 1 also requires at least one network interface 9 via which the server 1 could communicate with at least one client device 2 over a communications network. It will be understood by those skilled in the art of network and hardware and software design that certain server 1 architectures might include more than one network interface 9, and any type of the server 1 and network interface 9 design which enabled the communication of the server 1 with at least one client device 2 via a data network as outlined in the remainder of the method herein would all be contemplated within the scope of the present invention.

### Client Devices:

As outlined elsewhere herein, the method of the present invention explicitly contemplates the use of network enabled client devices 2 by users to initiate various types of data transactions under the remainder of the method. It will be understood by those skilled in the art client/server 1 application design that any type of a client device 2 which could communicate with the server 1 via a data network and a related network interface would be within the scope of the present invention. Smart phones, PCs and other remote and network capable computing devices are all devices understood to be contemplated within the context of client devices 2 and the scope of the present invention, insofar as they will each include a network interface by which the client device 2 could communicate via a data network with the server 1. The majority of these types of commercially available hardware devices will already include all the necessary hardware and software component 7 to participate in the method of the present invention. It will be understood by those skilled in the art client/server 1 remote application deployment that any type of a computing device capable of interaction with server 1 and any other remainder of the system of the present invention, and to interact with the server 1 and the remainder of its components via a data network are contemplated within the scope of the present invention.

The client device 2 may include pre-existing software such as a browser or local application for example, which could facilitate the method of the present invention or in other cases specific purpose built client software could be used. Architecturally and conceptually, the concept of “apps” use of smart phones and other personal devices is widely known. The specifics of implementing the client/server 1 software system using a website or a central bureau and an interface for the client device 2 of users will be easily understood by those skilled in the art of client/server 1 software design and the method of the present invention of implementing such a similar approach is contemplated within the scope of the present invention.

Conceptually, using the local app as the front end or interface of the server 1 of the present invention on a client device 2 is at least as likely as the possibility of using a web browser to facilitate the use of the method of the present invention. Development of either a browser interface or a local app interface as the user interface between the user of a client device 2 and the server 1 and the compliance monitoring software component 7, along with the remainder of the essentially hosted and executed method, will be understood to those skilled in the art of client/server 1 database and application design and again all such approaches are contemplated within the scope of the present invention.

### Communications Network:

It is specifically contemplated that the communications network used for communication between the server 1 and the client devices 2 could be the Internet or another publicly available wide-area network. The removal of a requirement for a proprietary or closed communications network between remote client devices 2 and the server 1 facilitating the method represents one significant enhancement and cost efficiency of the method of the present invention. The specific protocol of communication between the devices can vary, and different communication protocols could be used between different devices in the system. All such approaches and architectures will be understood to those skilled in the art of wide-area computer network design and all are contemplated within the scope of the present invention. In certain embodiments of the server 1 and the method of the present invention more than one communications network might be used.

It will be understood that private networks in place of the internet albeit with the added cost and complexity in terms of client software communication. Both such approaches are contemplated within the scope of the present invention. Also contemplated is a scenario in which more than one communications network was used i.e. one communications that work at a first network interface on the server 18 communicate with one or more client devices 2 of a particular type, and a separate network interface and/or data network might facilitate communications with other devices.

### Participant Database:

In the architecture shown there is shown a data store 8 operatively connected to the remainder of the server 1 which contains the various required data for operating the method of the present invention. Any type of a data structure capable of storing the information for the required data subsets regarding participants 40, projects 45 and qualifications is contemplated herein. The data store 8 might be resident on the server 1, or it might be located and administered remotely and operatively connected with the server 1 via a network or other communications bus. One data structure required to facilitate the practice of the method of the present invention in operable connection to the server 1 is a participant database or participant dataset. The participant database would include various information pertaining to individual human assets participating in the method of present invention.

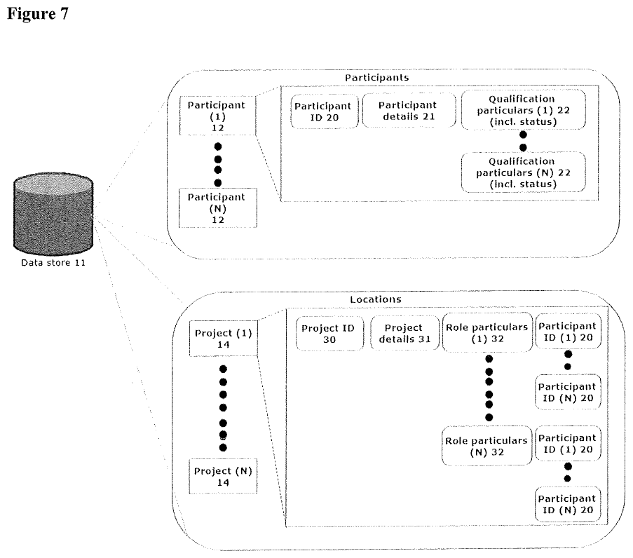

FIG. 7 shows one representative embodiment of a data structure of a participant dataset in accordance with the remainder of the present invention. A plurality of participant records 12 is shown. In this particular case, two participant records 12 are shown although it will be understood that any number of participant records 12 are contemplated within the scope of the present invention. In most types of database designs, each participant record 12 would be stored in association with a record key or a record ID shown in this case as the participant ID 20. This would usually be an internal data token assigned by the software 7 to allow indexing and referencing of the particular participant record 12 although the participant ID 20 rather than being a internally assigned data token could also represent an individual or entity specific data token captured regarding the related participant 40 in both such approaches are contemplated within the scope of the present invention. Besides the participant ID 20, participant details 41 would be captured and stored to a participant record 12. The participant details 41 will be a number of different types of information it was desired to track regarding an individual or group participant 40—name, address, non-qualification related information, or other items required for reporting more analysis purposes. The participant details 41 could comprise the same set of fields or same information regarding every participant record 12 or in some modifications or embodiments of the software on the server 1 of the present invention, the system could allow a particular participant 40 to voluntarily attach different participant details 41 either to position their qualifications for a particular project 45, or even in using the system of the present invention to provide a more fulsome ongoing training record for record-keeping purposes.

Besides the participant ID 20 and various types of participant details 41 21 which should be tracked regarding an individual participant 40 in the participant record 12, this Figure also shows the tracking of a plurality of qualification particulars 42 regarding this individual participant 40. The number of qualification particulars 42 which should be tracked regarding individual participant records 12 could vary—some participant records 12 might track as few as a single qualification particular 42, where other participants 40 and their related participant records 12 could track tens or hundreds of qualification particulars 42 accumulated by a particular participant 40 during a training career. In this particular case, the Figure shows records for two qualification particulars 42, but it will be understood that the number of those qualification particulars 42 tracked could vary. As outlined elsewhere herein the qualification particulars 42 would include necessary details of particular training qualifications acquired or maintained by the related participant 40 including the information for the compliance monitoring software component 7 to monitor and test the active or inactive status of such qualifications.

Various ways of streamlining the method of the present invention can be contemplated which might include the incorporation of a checklist or a centralized list of qualification types and formats stored somewhere within the data stored in row 11 in association with the participant database—if a checklist or a centralized qualification component for use it could permit for the rapid entry of qualification particulars 42 by a user regarding a particular participant record 12, and if a centralized list were used, the list could also similarly be used in the assignment of role particulars to particular project records 14 and will allow for rapid and more standardized crosschecking between the participant records 12 and the requirements of particular projects 45 as outlined regarding individual project records 14. It will however be understood that everything from a streamlined picklist approach through to a more fulsome data interface and the tracking of more detailed qualification particulars 42 regarding the participant records 12 would all be understood to those skilled in the art of data structure design and software of this nature and are all contemplated.

The participant database could be any type of a data structure capable of administering and maintaining and storing the necessary information outlined herein for the purpose of the method. The participant database could comprise a freestanding data structure, or could comprise a subset of records located within a combined a data structure along with the project database and other required information for the administration of the method—both such approaches are contemplated within the scope of the present invention. Several types of participant database structures, relational, flat or otherwise, will all be understood to those skilled in the art and are contemplated within the scope.

### Project Database:

Another data structure required to facilitate practice the method of the present invention in operable connection server 1 is a project database or data set consisting of a plurality of project records 14 each of which contains various information pertaining to a project 45 being administered under the method of the present invention. As in the case of the participant database, the project database can be any type of data structure capable of administering and maintaining and storing the information outlined herein for the method. Several types of project database structures and datasets, including relational, flat or otherwise, will all be understood to those skilled in the art and are contemplated within the scope of the present invention.

The sample data structure outlined in FIG. 7 is an indicative look at what certain types of datasets or project data structures might look like under the remainder of the present invention. As in the case of the participant records 12, the project records 14 and the related data structure are shown—any number of project records 14 corresponding to each to a project 45 being administered are understood to potentially be within the scope of the present invention. In this particular case, two project records 14 are demonstrated. In most types of database designs, each project record 14 would be stored in association with a record key or a record ID, which is shown as the project ID 30. This would usually be an internal data token assigned by the software component 7 to allow indexing and referencing of the particular project record 14, although the project ID 30 rather than being an internally assigned data token could also represent an individual or project specific data token captured regarding the related project 45 and both such approaches are contemplated herein.

Besides the project ID 30, project details 46 are stored. The project details 46 could be several types of information was desired to track regarding an individual project 45. For example the name, address or other details of the project 45 for the project proponent, or other information required for reporting, compliance or analysis purposes. The project details 46 could comprise the same set of fields or same information regarding every project record 14, or sometimes modifications or embodiments of the software on the server 1 of the present invention could be created which will allow a particular project 45 creator or proponent to voluntarily attach different project details 46 regarding a particular project 45 and project record 14.

The required qualifications 48 would exist as role particulars 32 stored regarding a particular project record 14. The role particulars 32 stored regarding a particular project 45 and project record 14 could effectively be stored so a particular role particular 32 sub record was created regarding each individual participant 40 required to be assigned regarding a particular task or some role within the project 45, or other types of data structures can obviously be created, but the general idea to communicate the outline of the intended subject matter in scope and coverage of the application is that the role particulars 32 would be attached to each project record 14 and would define the qualification of individual participants 40 as represented by their participant records 12 for participation in a particular project 45 being monitored in accordance with the system and method of the present invention. Purely for demonstrative purposes, a project 45 might be created regarding which there was a requirement for three electricians and two millwrights to work on the project 45. There, the electrician role might have one role particular token or subrecord 32 created an association therewith, and the millwright role might have another role particular sub record or token created regarding the project record 14. Within each of those role particulars 32 additional qualifications or requirements can also be incorporated.

As outlined above regarding the participant 40 dataset and the participant records 12, the association of particular qualifications 42 with the role particulars 32 of a particular project record 14 could be done by incorporating a cross reference pick list of qualification types or the like which could be used both for the creation of participant records 12 and project records 14, which would allow for easy and rapid comparison and selection of matching qualifications between participants 40 and projects 45 in the administration of the method. It will also be understood that different data formats or fields could store sufficient information to allow for the matching of dissident and project 45 qualifications and requirements and again both such approaches are contemplated within the scope of the present invention and will be understood to those skilled in the art of database design and query design.

The final thing shown in the project record 14 sample shown in FIG. 7 is a plurality of participants 40 being associated with particular roles in a project 45, by associating a plurality of participants 40 by linking of their participant record 12 using their participant ID 20 or the like to particular role particulars 32 associated with the project record 14. In the sample record shown, there are 2 participant records 12 shown linked to each of two role particulars 32 although it will be understood that several types and numbers of participants 40 could be accommodated and the actual data structure which would permit the matching of participant records 12 with particular role particulars of project records 14 could be done as shown, or could also be done in a separate matching or concordance data table or the like. Several data structures which could achieve the results to practice the method of the present invention namely storing the identity or relation of particular participants 40 with projects 45 represented by participant 40 and project records 14 will again be understood to those skilled in the art of software and data structure design and all such approaches are contemplated within the scope.

As outlined, various ways of streamlining the method of the present invention can be contemplated might include the incorporation of checklists or centralized lists of qualification types and formats stored within the data store 11 which could be associated with the project database—if a checklist or a centralized qualification component were used to permit for rapid selection or entry of qualification requirements by user regarding a particular project record 14 and particular project 45 role and role particulars 32. It will as outlined above however be understood that everything from streamlined pick list or pre-population approaches through to a more fulsome data interface and the relation to the tracking of more detail qualification particulars 42 regarding participant records 12 and the associated project records 14 would all be encompassed by the invention.

The participant records 12 and the project records 14 could be located within the same data store 11 and within the same data entity, or could comprise separate data entities within multiple data stores 11. Both such approaches will be understood to those skilled in the database and data structure designed and architecture and are all contemplated within the scope of the present invention.

### Compliance Monitoring Software Component:

The compliance monitoring software component 7 will be any set of processor instructions which could be executed on a server 1 under the remainder of the disclosure outlined which would allow for the execution of the method steps of the claims appended. The subroutines in FIGS. 2, 3 and 4 demonstrate many types of data handling steps and data input and output steps required to be executed by the software 7—any software capable of performing this function is contemplated within the scope of the present invention.

It will also be understood that the compliance monitoring software component 7 or other software component installed in association with the server 1 could provide additional functionality beyond the core compliance monitoring workflow outlined in the claims at this application. For example additional data reporting, query functionality and many other different business workflow steps could be facilitated using the same dataset which is contemplated i.e. dataset matching qualified participants 40 to projects 45 being administered. Any additional software component which would permit the extension of these added functions to the dataset created for the administration of the method outlined will be understood to be contemplated within the scope of the present invention.

### Monitoring Qualification Currency:

One of the primary elements of the method of the present invention is the monitoring by the compliance monitoring software component 7 of the active or inactive status of any individual participant qualifications 42 stored in participant records 12 in the participant database or dataset. Sometimes simply the existence of a particular training certifications qualification on behalf of a participant 40 can be treated as an active status indefinitely, and in other cases, particular training certifications or qualifications on behalf of a participant 40 require ongoing maintenance, supplemental training or the like and it is desired to track the currency or expiry of any such qualifications insofar as they might be attached as required qualifications to a particular project 45.

When a particular participant qualification 42 is stored within a participant record 12, the necessary information to monitor the active or inactive status of that particular qualification is formatted and stored in relation to that qualification in the record 12. The compliance monitoring software component 7 can then either on a real-time ongoing basis or on a periodic scan basis monitor the expiry of the active status of any qualifications stored regarding any participant records 12 so the next time a project verification is undertaken any inactive status qualifications can be flagged for follow-up. The alternative to monitoring each individual qualification of each individual participant 40 outlined in participant records 12 ongoing would be to test or sample that status information for each required qualification regarding a actual verification pass being made over the participant database regarding a particular project 45 or project record 14. Both such approaches are contemplated within the scope of the present invention.

Monitoring of the active or inactive status of individual qualifications of participants 40 stored in participant records 12 could be conducted by the compliance monitoring software component 7 or there could be a separate status monitoring agent or software component 7 incorporated into the overarching design of the server 1 and execution of the method and it will be understood that the modifications to the software design to accommodate such an architecture are all contemplated within the scope of the present invention. The record structure and software designed to accommodate the straightforward monitoring of the active or inactive status of one or more participant qualifications 42 memorialized in participant records 12 stored within the server 1 and the dataset will be understood to those skilled in the art of relational database design and are all contemplated within the scope of the present invention.

As outlined throughout this document one of the key components of the method of the present invention is the ability of the system and the method as outlined to on an ongoing basis comfort proponents or operators that any assigned human participants 40 in their projects 45 remain current regarding any required qualifications, training certifications and the like. One of the key components of the method of the present invention is that the compliance monitoring software component 7 includes a subroutine or processor instructions which could verify the current compliance out of one or more projects 45 as required. As outlined in the claims and discussed in detail under the general method outlined above, the system of the present invention could verify the qualification compliance at least one project 45 on the occurrence of a verification trigger which comprises an event received by the server 1 detected by the server 1 regarding which a verification sequence of steps could be administered regarding at least one project 45. Various types of verification triggers are contemplated within the scope of the present invention, including providing an ability for a user associated with a particular project 45 and project record 14 to manually initiate a verification check on that project 45 and its compliance by for example manually sending a verification trigger from a client device 2 to the server 1. In other cases, the verification trigger could actually be detection by the server 1 of the arrival of a preprogrammed time event or frequency within which it would be desired to periodically verify the qualification compliance of one, many or all of the projects 45 administered under the remainder of the method. Any type of a verification trigger is contemplated within the scope of the invention—even a combination of different types of triggers could be used i.e. periodic verification coupled with the ability for a user to initiate an immediate verification event could also be used.

The verification trigger which could be used could also comprise a status change regarding a participant qualification 42 a participant record 12. I.e. if the system incorporated an ongoing and real time monitoring loop against the participant records 12 in the participant database to monitor any expiry of qualifications outlined, the detection of the change in status from active to inactive of one or more participant qualifications 42 outlined in one or more participant records 12 in the participant database could itself comprise the verification trigger which would cause the initiation of a qualification compliance check out at least one of the project 45 outlined in accordance with a project record 14 in the project database.

### Portable Profile:

As outlined above and throughout, one of the key elements of the method of the present invention is that it results in creating effectively a portable qualification profile record regarding individual project participants 40, which can be built and maintained by an individual participant 40 over time regardless of particular project 45 or employment status. It is explicitly contemplated that the participant records 12 of the system of the present invention would effectively be the “property” of the individual participant 40 and not their employer or a project proponent. While the system could permit for the tracking of the currency of project or employer specific qualifications, the individual participant 40 could continue to access, use and maintain their participant record 12 regardless of completing a particular project 45 or a particular employment. It is also specifically contemplated that the method of the present invention will be useful in the administration of projects 45 incorporating several individual participants 40 who might be working on multiple projects 45 of multiple proponents simultaneously and the portability or the cross project 45 capability of the system of the present invention would be useful in this environment.

In some embodiments of the method of the present invention, the portable profile aspect of the methodology could be maximized by, at the completion of the project 45 represented by a project record 14, storing information in each participant record 12 of a participant 40 having been associated with the completion of the project 45 or in relation to the related project 45 and participant records 12, by which a historical log of project 45 completions or demonstrative project 45 tasks and roles could be built in conjunction with the training profile of the participant 40 represented by the participant record 12 and included in future reporting.

Although the present technology has been described for illustration based on what is currently considered the most practical and preferred implementations, it is to be understood that such detail is solely for that purpose and that the technology is not limited to the disclosed implementations, but, on the contrary, should cover modifications and equivalent arrangements within the spirit and scope of the appended claims. For example, it is to be understood that the present technology contemplates that, to the extent possible, one or more features of any implementation can be combined with one or more features of any other implementation.

In addition, it will be apparent to those of skill in the art that by routine modification the present invention can be optimized for a wide range of conditions and application. It will also be obvious to those of skill in the art there are various ways and designs with which to produce the apparatus and methods of the present invention. The illustrated embodiments are therefore not intended to limit the invention, but to provide examples of the apparatus and method to enable those of skill in the art to appreciate the inventive concept.

What is claimed is:

1. A method of monitoring training and skills compliance for projects requiring the use of human project participants, the method comprising:
a) providing a server including:
i) a network interface for communication with client devices;
ii) a compliance monitoring software component for carrying out the data handling steps of the method;
iii) a participant database comprising a plurality of participant records each corresponding to an individual project participant and comprising participant details of the project participant and qualification particulars of at least one qualification, wherein the qualification particulars contain the details of the active or inactive status of the qualification; and
iv) a project database comprising a plurality of project records each corresponding to a project and comprising project details and role particulars of at least one participant role associated with the project having at least one required qualification, corresponding to a tracked qualification from the participant database, for at least one project participant to be assigned to the participant role;
b) permitting users to interact via client devices in communication with the server and the compliance monitoring software component to update participant records and project records as required;
c) using the server and the compliance monitoring software component:
i) on receipt of a participant creation request from a user via a client device:
(1) facilitating data entry at the client device of participant details of the project participant;
(2) facilitating data entry at the client device of the qualification particulars for each qualification of the corresponding project participant, including the details of active or inactive status of the qualification;
(3) receiving a transmission of the entered participant details and qualification particulars at the server from the client device;
(4) formatting the qualification particulars received as required so they can be stored in a format that will permit the compliance monitoring software component to monitor any expiry of the active status of the qualifications; and
(5) creating and saving a participant record in the participant database containing the received participant details and qualification particulars;
ii) on receipt of a project creation request from a user via a client device:
(1) facilitating data entry at the client device of project details;
(2) facilitating data entry at the client device of role particulars for each participant role to be associated with the project including all required training requirements for each project participant to be assigned to each participant role;
(3) receiving a transmission of the entered project details and role particulars at the server from the client device;
(4) facilitating the association of qualified project participants to any participant roles within the received role particulars by, for each participant role:
(a) selecting participant records from the participant database that indicate project participants with active qualifications for all of the participant training requirements for the role, being the selected participant records;
(b) displaying the details of the selected participant records on the client device and permitting the user to select the required number of selected project participants therefrom for association with the participant role, being the participant association details;
(5) receiving a transmission of the participant association details, being the details of the selected project participants and their associated participant records, at the server; and
(6) creating and saving a project record in the project database containing the project details, the role particulars and the participant association details;
iii) verifying the qualification compliance of at least one project on occurrence of a verification trigger event by, for each project record of a project to be verified:
(1) for each participant role associated with the project, verifying the active status of each required qualification from each participant record associated with the participant role in the project record, any participant record corresponding to a required qualification without active status being a noncompliant participant record; and
(2) if any noncompliant participant records are identified regarding the project, notifying a designated user associated with the project record of the details of any noncompliant participant records requiring rectification;
wherein the participant record of a project participant survives any individual active project or employment status of the project participant.

2. The method of claim 1, wherein a verification trigger event is selected from the group of: a manually triggered verification by a client device in communication with the server; or a predetermined periodic verification interval.

3. The method of claim 1, wherein a verification trigger event occurs regarding a single project record in the project database.

4. The method of claim 1, wherein a verification trigger event occurs in respect of a plurality of project records in the project database.

5. The method of claim 1, wherein the project records represent projects of more than one organization.

6. The method of claim 5, wherein a participant record is associated with the project records of projects of more than one organization.

7. The method of claim 1, wherein a project participant has more than one qualification stored within their associated participant record.

8. The method of claim 1, further comprising notifying the associated project participant via a notification to a client device as any change in the active status of a qualification is detected.

9. The method of claim 1, wherein at least one participant record represents an individual project participant.

10. The method of claim 1 wherein at least one participant record represents a group of individual project participants each having their own participant record, with group level qualifications associated therewith while the individual participant records of individual project participants are still maintained.

11. The method of claim 1, wherein the server is a web server, the network interface connects the server to the internet, and the client devices are internet-connected devices capable of interaction with the server and its related software component.

12. The method of claim 1, wherein notification of noncompliant participant records it is transmitted to the designated user associated with the project record by email or other electronic notification.

13. The method of claim 1, wherein tracked participant qualifications of participants in participant records, and the corresponding required qualifications in respect of projects in project records can be selected from the group of: physical or geographic locations of residence, physical or geographic locations availability for work, completion of particular educational courses or diplomas, completion and maintenance of particular ongoing professional certifications, or possession of particular training and skills.

14. The method of claim 1, wherein upon the completion of a project represented by a project record, the participant records of any human participants associated with participant roles within the project are modified to store and indication of the participation of the corresponding human participant in the completed project, whereby future database queries related to the participant records in question can reveal a completed project log in respect of the associated participant.

15. The method of claim 15, wherein tracked participant qualifications of participants in participant records, and the corresponding required qualifications in respect of projects in project records, can be past project experience of a participant as stored in respect of their participant record.

16. The method of claim 1, wherein the server and the compliance monitoring software component provide functionality by which at least one participant record can be accessed in a general participant search outside of its association with a particular project record.

17. A server configured for determining training and skills compliance for projects requiring the use of project participants, the server comprising:
a) a non-transient computer-readable storage medium having executable instructions comprising a compliance monitoring software component embodied thereon;
b) a participant database comprising a plurality of participant records each corresponding to an individual project participant and comprising details of at least one qualification of the associated project participant including its active or inactive status;
c) a project database comprising a plurality of project records each corresponding to a project and comprising details of a plurality of associated participant roles in the project each having at least one required qualification for individual project participants to be assigned to the participant role;
d) a network interface for communication with client devices; and
e) one or more hardware processors configured to execute the instructions of the compliance monitoring software component to:
f) permit users to interact via client devices in communication with the server and the compliance monitoring software component to update participant records and project records as required;
g) on receipt of a participant creation request from a user via a client device:
i) facilitate data entry at the client device of participant details of the project participant;
ii) facilitate data entry at the client device of the qualification particulars for each qualification of the corresponding project participant, including the details of active or inactive status of the qualification;
iii) receive a transmission of the entered participant details and qualification particulars at the server from the client device;
iv) format the qualification particulars received as required so they can be stored in a format that will permit the compliance monitoring software component to monitor any expiry of the active status of the qualifications; and
v) create and save a participant record in the participant database containing the received participant details and qualification particulars;
h) on receipt of a project creation request from a user via a client device:
i) facilitate data entry at the client device of project details;
ii) facilitate data entry at the client device of role particulars for each participant role to be associated with the project including all required qualifications for each project participant to be assigned to each participant role;
iii) receive a transmission of the entered project details and role particulars at the server from the client device;
iv) facilitate the association of qualified project participants to any participant roles within the received role particulars by, for each participant role:
(1) selecting participant records from the participant database that indicate project participants with active qualifications for all of the required qualifications for the role, being the selected participant records;
(2) displaying the details of the selected participant records on the client device and permitting the user to select the required number of selected project participants therefrom for association with the participant role;
v) receiving a transmission of the participant association details, being the details of the selected project participants and their associated participant records, to the server; and
vi) creating and saving a project record in the project database containing the project details, the role particulars and the participant association details;
i) verify the qualification compliance of at least one project on occurrence of a verification trigger event by, for each project record of a project to be verified:
i) for each participant role associated with the project, verifying the active status of each required qualification from each participant record associated with the participant role in the project record, any participant record corresponding to a required qualification without active status being a noncompliant participant record; and
ii) if any noncompliant participant records are identified regarding the project, notifying a designated user associated with the project record of the details of any noncompliant participant records requiring rectification;
wherein the participant record of a project participant survives any individual active project or employment status of the project participant.

18. The server of claim 18, wherein a verification trigger event is selected from the group of: a manually triggered verification by a client device in communication with the server; or a predetermined periodic verification interval.

19. The server of claim 18, wherein a verification trigger event occurs regarding a single project record in the project database.

20. The server of claim 18, wherein a verification trigger event occurs regarding a plurality of project records in the project database.

21. The server of claim 18, further comprising notifying the associated project participant via a notification to a client device as any change in the active status of an qualification is detected.

22. The server of claim 18, wherein notification of noncompliant participant records it is transmitted to the designated user associated with the project record by email or other electronic notification.

23. The server of claim 18, wherein tracked participant qualifications of participants in participant records, and the corresponding required qualifications in respect of projects in project records can be selected from the group of: physical or geographic locations of residence, physical or geographic locations availability for work, completion of particular educational courses or diplomas, completion and maintenance of particular ongoing professional certifications, or possession of particular training and skills.

24. The server of claim 18, wherein upon the completion of a project represented by a project record, the participant records of any human participants associated with participant roles within the project are modified to store and indication of the participation of the corresponding human participant in the completed project, whereby future database queries related to the participant records in question can reveal a completed project log in respect of the associated participant.

25. The server of claim 25, wherein tracked participant qualifications of participants in participant records, and the corresponding required qualifications in respect of projects in project records, can be past project experience of a participant as stored in respect of their participant record.

26. The server of claim 18, wherein the server and the compliance monitoring software component provide functionality by which at least one participant record can be accessed in a general participant search outside of its association with a particular project record.

27. The server of claim 18, wherein at least one participant record represents an individual project participant.

28. The server of claim 18, wherein at least one participant record represents a group of individual project participants each having their own participant record, with group level qualifications associated therewith while the individual participant records of individual project participants are still maintained.
